(19) United States
(12) Patent Application Publication
(10) Pub. No.: US 2023/0393061 A1
(43) Pub. Date: Dec. 7, 2023

(54) OPTICAL DETECTOR AND METHOD FOR DETERMINING AT LEAST ONE PROPERTY OF AT LEAST ONE SUBSTANCE

(71) Applicant: trinamiX GmbH, Ludwigshafen am Rhein (DE)

(72) Inventors: Henning ZIMMERMANN, Ludwigshafen (DE); Sebastian VALOUCH, Ludwigshafen (DE); Daniel KAELBLEIN, Ludwigshafen (DE); Robert SEND, Karlsruhe (DE)

(21) Appl. No.: 18/249,311

(22) PCT Filed: Oct. 25, 2021
(86) PCT No.: PCT/EP2021/079448

§ 371 Date: Apr. 17, 2023

(30) Foreign Application Priority Data
Oct. 26, 2020 (EP) 20203818.8

(51) Int. Cl. G01N 21/3504; G01J 3/10; G01J 3/36; G01J 3/42

(52) U.S. Cl. CPC G01N 21/3504; G01J 3/108; G01J 3/36; G01J 3/42; G01J 2003/1213

(57) ABSTRACT

Disclosed herein is an optical detector and a method for determining at least one property of at least one substance. The optical detector and the method allow measuring both an intensity I₀ of a first illumination before interacting with the at least one substance and an intensity I₁ of a second illumination after interacting with the at least one substance in a simultaneous fashion in a single measurement, thereby enabling multi-gas sensing.

### FIELD OF THE INVENTION

The invention relates to an optical detector and a method for determining at least one property of at least one substance. Such devices and methods can be used for monitoring or investigation purposes, in particular within the infrared (IR) spectral range. Typical applications include spectroscopy, gas sensing, or concentration measurements. However, further applications are possible.

### PRIOR ART

Infrared spectra are usually measured relative to a background spectrum, wherein the background spectrum comprises information about at least one of an illumination spectrum, a background light, or a functionality of the spectrometer system. According to Equation (1), the well-known Beer-Lambert Law,

I₁=I₀·e^{-εcd} (1)

provides a correspondence at a given wavelength between an intensity I₀ of a first illumination before interacting with a sample and an intensity I₁ of a second illumination after interacting with the sample, whereas d denotes a length of a path of the illumination passing through the sample, while ε and c denote a quantity of the at least one substance as comprised by the sample, i.e. an extinction coefficient c and a concentration c. In general, the length d of the path of the illumination through the sample is known, such that a product of the two quantities, i.e. the extinction coefficient ε of the substance and the concentration c of the substance within the sample, can be determined. Alternatively, the extinction coefficient ε of the substance or the concentration c of the substance within the sample can be determined if the other quantity is known.

Usually, the intensity I₀ of the first illumination before interacting with the sample is determined by using a separate detector, typically, by performing a separate measurement. However, it would be desirable to measure both the intensity I₀ of the first illumination before interacting with the sample and the intensity I₁ of the second illumination after interacting with the sample simultaneously by performing a single measurement. Further, it would be desirable to measure the intensity I₀ of the first illumination before interacting with the sample directly in front of the sample, and the intensity I₁ of the second illumination after interacting with the sample directly behind the sample in fashion that the illumination travels in a single pathway.

WO 2016/120392 A1 discloses an optical sensor designed to generate at least one sensor signal in a manner dependent on an illumination of the sensor region. Herein, a sensor region of the longitudinal optical sensor comprises a photoconductive material, wherein an electrical conductivity in the photoconductive material, given the same total power of the illumination, is dependent on the beam cross-section of the light beam in the sensor region. As a result, the longitudinal sensor signal is dependent on the electrical conductivity of the photoconductive material. Preferably, the photoconductive material is selected from lead sulfide (PbS), lead selenide (PbSe), lead telluride (PbTe), cadmium telluride (CdTe), indium phosphide (InP), cadmium sulfide (CdS), cadmium selenide (CdSe), indium antimonide (InSb), mercury cadmium telluride (HgCdTe; MCT), copper indium sulfide (CIS), copper indium gallium selenide (CIGS), zinc sulfide (ZnS), zinc selenide (ZnSe), or copper zinc tin sulfide (CZTS). Further, solid solutions and/or doped variants thereof are also feasible. Further, a transversal optical sensor having a sensor area is disclosed, wherein the sensor area comprises a layer of the photoconductive material, preferentially embedded in between two layers of a transparent conducting oxide, and at least two electrodes. Preferably, at least one of the electrodes may be a split electrode having at least two partial electrodes, wherein transversal sensor signals provided by the partial electrodes indicate an x- and/or a y-position of the incident light beam within the sensor area.

WO 2018/019921 A1 discloses an optical sensor comprising a layer of at least one photoconductive material, at least two individual electrical contacts contacting the layer of the photoconductive material, and a cover layer deposited on the layer of the photoconductive material, wherein the cover layer is an amorphous layer comprising at least one metal-containing compound. The optical sensor can be supplied as a non-bulky hermetic package which may, nevertheless, provide a high degree of protection against possible degradation by humidity and/or oxygen. Moreover, the cover layer is capable of activating the photoconductive material which results in an increased performance of the optical sensor. Further, the optical sensor may be easily manufactured and integrated on a circuit carrier device.

WO 2018/077870 A1 discloses an optical detector for an optical detection, in particular, of radiation within the infrared spectral range, specifically, with regard to sensing at least one optically conceivable property of an object. More particular, the optical detector may be used for determining transmissivity, absorption, emission, reflectance, and/or a position of at least one object. Further, the invention relates to a method for manufacturing the optical detector and to various uses of the optical detector. The optical detector comprises an optical filter having at least a first surface and a second surface, the second surface being located oppositely with respect to the first surface, wherein the optical filter is designed for allowing an incident light beam received by the first surface to pass through the optical filter to the second surface, thereby generating a modified light beam by modifying a spectral composition of the incident light beam; a sensor layer comprising a photosensitive material being deposited on the second surface of the optical filter, wherein the sensor layer is designed to generate at least one sensor signal in a manner dependent on an illumination of the sensor layer by the modified light beam; and an evaluation device designed to generate at least one item of information provided by the incident light beam by evaluating the sensor signal.

WO 2020/148381 A1 discloses an optical sensor comprising a substrate attached to a circuit carrier device, a layer of at least one photoconductive material which is directly or indirectly applied to the substrate, at least two individual electrical contacts contacting the layer of the photoconductive material, and a cover covering accessible surfaces of the layer of the photoconductive material and of the substrate, wherein the cover is an amorphous cover which comprises at least one metal-containing compound, wherein at least one of the substrate and the cover is optically transparent within a wavelength range. A manufacturing method for the optical sensor is also provided. The optical sensor can, thus, be supplied as a non-bulky hermetic package which provides an increased degree of protection against possible degradation by humidity and/or oxygen over long terms. Further, the optical sensor may be easily manufactured and integrated on a circuit carrier device.

U.S. Pat. No. 4,700,073 A discloses an infrared photometer having a measuring cuvette with entrance and exit windows and an output detector preferably made of polyvinylidenfluoride; a second infrared detector definitely made of polyvinylidenfluoride, being partially transmissive disposed in front of the entrance window of the cuvette; and a selecting cuvette insertable in front of this second detector.

P. C. A. Hammes and P. P. L. Regtien, An integrated infrared sensor using the pyroelectric polymer PVDF, Sensors and Actuators A, 32 (1992) 396-402, discuss two types of pyroelectric sensor set-ups using the pyroelectric polymer PVDF. In the first set-up, a PVDF membrane is mounted on a support ring. As a result, the material is thermally well-isolated and the thermal sensitivity of this configuration is high. On the other hand, this set-up is not very robust as the wires, which can be numerous in the case of a matrix sensor, connecting the PVDF sensor to the readout electronics are vulnerable. The second set-up discussed solves this problem. Herein, the PVDF foil is glued to a silicon substrate containing the readout circuitry. A MOSFET is used to read out the pyroelectrically generated signal.

U.S. Pat. No. 5,861,626 A discloses a multiple film integrated infrared (IR) detector assembly consisting of various detector films having different IR spectral sensitivities deposited on a breadboard IR transmissive but electrically insulating substrate. The substrate is deposited on an IR filter layer comprising an HgCdTe film, wherein the film has a varying composition from edge to edge. This compositional gradient of film results in varying IR spectral absorption. The film acts as a graded IR filter in concert with the response of the detector films. Hereby, an integrated IR spectrometer may be fabricated whereby each detector detects only specific narrow bands of IR wavelengths.

Despite the advantages as implied by the above-mentioned detectors and methods, there still is a need for improvements with respect to a simple, cost-efficient and reliable optical detector which can be used, in particular within the infrared (IR) spectral range, for monitoring or investigation purposes, especially for spectroscopy, gas sensing, or concentration measurements.

### Problem Addressed by the Invention

Therefore, a problem addressed by the present invention is that of specifying an optical detector and a method for determining at least one property of at least one substance which at least substantially avoids the disadvantages of known optical detectors and methods of this type.

In particular, it would be desirable to be able to measure both an intensity I₀ of a first illumination before interacting with the sample and an intensity I₁ of a second illumination after interacting with the sample simultaneously in a single measurement. Further, it would be desirable to measure the intensity I₀ of the first illumination before interacting with the sample directly in front of the sample, and the intensity I₁ of the second illumination after interacting with the sample directly behind the sample, wherein, the illumination may, preferably, travel in a single pathway.

### SUMMARY OF THE INVENTION

This problem is solved by the invention with the features of the independent patent claims.

Advantageous developments of the invention, which can be realized individually or in combination, are presented in the dependent claims and/or in the following specification and detailed embodiments.

In a first aspect of the present invention, an optical detector for determining at least one property of at least one substance is disclosed, wherein the optical detector comprises:
at least one first optical sensor comprising at least one first sensor layer, wherein the at least one first optical sensor is configured to generate at least one first sensor signal depending on a first illumination illuminating at least a portion of the at least one first sensor layer;
at least one second optical sensor comprising at least one second sensor layer, wherein the at least one second optical sensor is configured to generate at least one second sensor signal depending on a second illumination illuminating at least a portion of the at least one second sensor layer;

wherein the at least one first optical sensor and the at least one second optical sensor are spaced apart from each other in a manner that a volume between the at least one first optical sensor and the at least one second optical sensor is designated for receiving at least one substance, wherein the at least one first optical sensor is configured to transmit a share of the first illumination into the volume; and
at least one evaluation unit configured to generate at least one item of information about at least one property of the at least one substance by evaluating the at least one first sensor signal and the at least one second sensor signal.

Herein, the listed components may be individual components. Alternatively, at least two of the components may be integrated into a single component. Herein, the at least one evaluation unit may, in particular, be formed as an individual evaluation unit independent from the at least one first optical sensor and the at least one second optical sensor but may, preferably, be connected to the first optical sensor and to the second optical sensor to receive the at least one first sensor signal and the at least one second sensor signal. Alternatively, the at least one evaluation unit may, fully or partially, be integrated into the at least one first optical sensor and/or into the at least one second optical sensor.

As used herein, the term “substance” refers to at least one compound comprised by an arbitrary sample or a portion thereof. In particular, the substance may be a substance to be analyzed, wherein the term “to be analyzed” relates to generating the desired information about the at least one property of the at least one substance, especially by using the optical detector according to the present invention to. Herein, the at least one substance may be selected from at least one of a liquid; a gas; a solid body, in particular a powder, a granulate, or a bulk material; or a mixture thereof. In general, a particular substance may comprise at least one component, wherein a composition of the substance can remain constant or change during the monitoring of the particular substance. In particular, to enable a portion of the first illumination to pass through the sample, whereby it is modified into a second illumination which illuminates the at least one second sensor layer of the second optical sensor, a layer of the at least one substance is partially transparent. As generally used, the term “partially transparent” refers to a property of the at least one substance that a non-vanishing portion of the first illumination is capable of passing a layer formed by the at least one substance whereby it is modified into the second illumination.

As further used herein, the term “property” of at least one substance relates to an optically receivable quantity of the at least one substance as comprised by the sample. As further used herein, the term “determining” refers to acquiring at least one value, in particular at least one representative value, for the at least one property of the at least one substance. Preferably, the at least one property of the at least one substance may be selected from at least one of an extinction coefficient ε and a concentration c of the at least one substance as comprised by the sample. As generally used, the term “extinction coefficient” refers to an attenuation of an illumination after travelling a distance d through the sample and is, therefore, related to the property of the at least one substance that it is partially transparent. As further generally used, the term “concentration” refers to a proportion of the at least one compound which is by the sample. In general, the distance d along which the illumination travels through the sample is known. According to Equation (1), a product of the extinction coefficient c and the concentration c of the at least one substance within the sample can, thus, be determined. Alternatively, the extinction coefficient ε or the concentration c of the at least one substance within the sample can be determined individually if the other quantity is known.

As further used herein, the term “optical sensor” refers to an arbitrary device which comprises at least one sensor layer and is configured to generate at least one sensor signal in a manner dependent on an illumination of the sensor layer or a portion thereof by an illumination. Herein, the term “sensor layer” relates to a photosensitive body designated for receiving the illumination, wherein the illumination as received by the sensor layer triggers a generation of the at least one sensor signal, wherein the generation of the sensor signal is governed by a defined relationship between the sensor signal and the manner of the illumination of the sensor layer. As generally used, the term “layer” indicates that the photosensitive layer has extensions in two lateral dimensions that exceed the extension in a third dimension, denoted as “thickness” of the layer, by a factor of at least 5, at least 10, at least 20, or at least 50 or more, wherein the layer may be carried by a substrate, in particular, to provide stability and integrity to the layer.

Further, the term “sensor signal” refers to an arbitrary signal indicative of the least one of illumination illuminating the sensor layer. As an example, the sensor signal may be or may comprise a digital and/or an analog signal. As an example, the sensor signal may be or may comprise a voltage signal and/or a current signal. Additionally or alternatively, the sensor signal may be or may comprise digital data. The sensor signal may comprise a single signal value and/or a series of signal values. The sensor signal may further comprise an arbitrary signal which may be derived by combining two or more individual signals, such as by averaging two or more signals and/or by forming a quotient of two or more signals.

According to the present invention, the optical detector has at least one first optical sensor, also denominated as “reference sensor”, and at least one second optical sensor, also denominated as “measurement sensor”. Herein, the at least one first optical sensor comprises at least one first sensor layer, wherein the at least one first optical sensor is configured to generate at least one first sensor signal depending on an illumination of at least a portion of the at least one first sensor layer. As a result, the at least one first optical sensor is designated to perform a direct measurement of the intensity I₀ of the first illumination before interacting with the sample. Further, the at least one second optical sensor comprises at least one second sensor layer, wherein the at least one second optical sensor is configured to generate at least one second sensor signal depending on an illumination of at least a portion of the at least one second sensor layer. As a result, the at least one second optical sensor is designated to perform a direct measurement of the intensity I₁ of the second illumination after interacting with the sample. As further used herein, the terms “first” and “second” are considered as a description without specifying an order and without excluding a possibility that other elements of the same kind may be present.

As a result, the optical detector has a stack of optical sensors, wherein the stack comprises the at least one first optical sensor and the at least one second optical sensor. As used herein, the term “stack” refers to a particular kind of arrangement of the optical sensors along an axis, in particular along an optical axis of the optical detector. As further used herein, the term “optical axis” refers to a main direction of view of the optical detector. Preferably, the optical sensors may be arranged with the stack in a manner that the respective sensor layers are oriented in a perpendicular fashion with regard to the optical axis. As an example, the sensor layers of the individual optical sensors may be oriented in parallel, wherein slight angular tolerances might be tolerable, such as angular tolerances of no more than 10°, preferably of no more than 5°. In the stack, the particular optical sensor which is finally impinged by the illumination, can be transparent, partially transparent, or intransparent while the other optical sensor within the stack which are previously impinged by the illumination, can be transparent or partially transparent, but not intransparent, in particular in order to enable that all optical sensors within the stack are impinged by the illumination.

Further according to the present invention, the at least one first optical sensor and the at least one second optical sensor are spaced apart from each other. As used herein, the term “spaced apart” refers to a placement of the at least one first optical sensor and the at least one second optical sensor within the optical detector in a fashion that a non-vanishing distance is generated between the at least one first optical sensor and the at least one second optical sensor. In other words, In other words, the stack of optical detectors may be defined by a fixed mechanical connection between the at least one first optical sensor and the at least one second optical sensor, in particular, to provide a fixed volume between the at least one first optical sensor and the at least one second optical sensor. As a result, a fixed volume between the at least one first optical sensor and the at least one second optical sensor is generated which is, in accordance with the present invention, designated for receiving the at least one substance. As generally used, the term “volume” refers to a hollow body designated for accommodating the sample which comprises the at least one substance. Preferably, the fixed mechanical connection is arranged in a fashion that a cube shape may be obtained. In a preferred embodiment, the fixed mechanical connection may, further, act as a receptacle for at least one cuvette. As generally used, the term “cuvette” relates to a particular kind of receptacle which is, especially, designed for accommodating a liquid sample. Herein, the at least one cuvette may, specifically, comprise spatial dimensions which allow inserting the at least one cuvette into the volume. In particular, the volume may be confined by a plurality of boundaries, wherein at least two opposing boundaries may, especially, be, fully or at least partially, optically transparent windows which are designated to transmit the portion of the first illumination after passing the at least one first optical sensor to the sample and, subsequently, from the sample to the at least one second optical sensor. As particularly preferred, the at least one first optical sensor may be partially optically transparent and can, simultaneously, function as one of the transparent windows contributing to confine the volume. Similarly, the at least one second optical sensor can, simultaneously, assume the function of an opposing window. For further details, reference may be made to the description of the exemplary embodiments below.

In a particularly preferred embodiment, the at least one first sensor layer may, preferably, comprise at least one layer of at least one photoconductive material. As used herein, the term “photoconductive material” refers to a material being capable of sustaining an electrical current, thus exhibiting a specific electrical conductivity, wherein, specifically, the electrical conductivity is dependent on the illumination of the material. In this kind of material, the electrical current may be guided via at least one first electrical contact through the material to at least one second electrical contact, or vive-versa. For this purpose, the at least two individual electrical contacts may be applied at different locations of the sensor layer especially, in a fashion that the first electrical contact and the second electrical contact are electrically isolated with respect to each other while each of the first electrical contact and the second electrical contact are in direct connection with the sensor layer. Herein, the electrical contacts may comprise an evaporated metal layer easily be provided by known evaporation techniques. In particular, the evaporated metal layer may comprise one or more of gold, silver, aluminum, platinum, magnesium, chromium, or titanium. Alternatively, the electrical contacts may comprise a layer of graphene.

The at least one photoconductive material used in the at least one first sensor layer may, preferably, comprise at least one chalcogenide, wherein the at least one chalcogenide may be selected from a sulfide chalcogenide, a selenide chalcogenide, a telluride chalcogenide, a ternary chalcogenide, a quaternary chalcogenide, a higher chalcogenide, a solid solution and/or a doped variant thereof. As used herein, the term “solid solution” refers to a state of the photoconductive material in which at least one solute is comprised in a solvent, whereby a homogeneous phase is formed and wherein the crystal structure of the solvent may, generally, be unaltered by the presence of the solute. By way of example, binary PbSe may be solved in PbS leading to PbS₁₋ₓSeₓ, wherein x can vary from 0 to 1. As further used herein, the term “doped variant” may refer to a state of the photoconductive material in which single atoms apart from the constituents of the material itself are introduced onto sites within the crystal which are occupied by intrinsic atoms in the undoped state. Further, the term “chalcogenide” refers to a compound which comprises at least one group 16 element of the periodic table apart from an oxide, i.e. a sulfide, a selenide, and a telluride. Herein, the term “chalcogenide” may also include mixed chalcogenides, such as sulfoxides, sulfoselenides, or selenidotellurides. However, other inorganic photoconductive materials may equally be appropriate.

In a particularly preferred embodiment, the at least one layer of at least one photoconductive material may, especially, comprise indium gallium arsenide (InGaAs) for wavelengths of the illumination up to 2.6 μm, indium arsenide (InAs) for wavelengths up to 3.1 μm, lead sulfide (PbS) for wavelengths up to 3.5 μm, lead selenide (PbSe) for wavelengths up to 5 μm, indium antimonide (InSb) for wavelengths up to 5.5 μm; or mercury cadmium telluride (MCT, HgCdTe) for wavelengths up 16 μm. Since the photoconductive materials mentioned herein are, generally, known to exhibit a distinctive absorptive characteristic within the infrared spectral range, the at least one first sensor layer which comprises at least one of the mentioned photoconductive materials may, preferably, be sensitive to infrared radiation. However, other embodiments and/or further photoconductive materials may also be feasible, in particular copper indium sulfide (CIS), copper indium gallium selenide (CIGS), copper zinc tin sulfide (CZTS), zinc tin selenide (CZTSe), cadmium telluride (CdTe), mercury zinc telluride (HgZnTe), lead sulfoselenide (PbSSe), copper-zinc-tin sulfur-selenium chalcogenide (CZTSSe), molybdenum disulfide (MoS₂), or other photoconductive materials which have been disclosed in WO 2018/019921 A1.

The sensor layer may be fabricated by applying at least one deposition method which may be selected from the group consisting of: vacuum evaporation, sputtering, atomic layer deposition, chemical vapor deposition, spray pyrolysis, electrodeposition, anodization, electro-conversion, electro-less dip growth, successive ionic adsorption and reaction, chemical bath deposition, and solution-gas interface techniques. However other photoconductive materials as mentioned or referred to herein may also be feasible for this purpose and may also be treated in the same or in a similar fashion.

Preferably, the sensor layer may be fabricated by depositing the photoconductive material on an electrically insulating substrate. Herein, the sensor layer may be directly or indirectly applied to at least one substrate. However, a stand-alone sensor layer may also be feasible. As generally used, the term “substrate” refers to an elongated body which is adapted for carrying a layer of a material, specifically of the photoconductive material as used herein, in particular, for providing mechanical stability to the sensor layer as an advantageous fashion. Further, the term “directly” refers to an immediate attachment of the sensor layer to the substrate whereas the term “indirectly” relates to an attachment of the sensor layer to the substrate via at least one intermediate layer, in particular, a bonding layer. Preferably, the substrate may be provided as a layer having lateral extensions which exceed a thickness of the layer by a factor of at least 5, preferably of at least 25, more preferred of at least 100. The thickness of the substrate may, preferably, be of 10 μm, of 20 μm, of 50 μm, of 100 μm to 500 μm, to 1000 μm, to 2000 μm.

As an alternative to an electrically insulating substrate, a semiconducting substrate or an electrically conductive substrate may also be feasible, however, employing an electrically insulating interlayer which may be optically transparent within the desired wavelength range between the substrate and the sensor layer may be preferred. As particularly preferred, the material used for the substrate may exhibit optically transparent properties, especially within a wavelength or a wavelength range of the illumination. For this purpose, the substrate material may, especially, be selected from at least one of a transparent glass, silicon, germanium, a metal oxide, a metal or a semiconducting material, in particular from aluminum doped tin oxide (AZO), indium doped tin oxide (ITO), ZnS, or ZnSe, wherein glass or silicon are particularly preferred.

In this fashion, the first optical sensor can be provided, especially by depositing a selected photoconductive material on an appropriate substrate and by applying at least two individual electrical contacts to the sensor layer. In a preferred embodiment, the second optical sensor can be provided in a similar or, more preferred, in an identical fashion, wherein the second sensor layer may, preferably, comprise a layer of the same or of a different photoconductive material. In an alternative embodiment, the second sensor layer may be or comprise any known photosensitive element, in particular, a CCD chip, a CMOS chip, a pyroelectric element, a bolometric element, a thermopile element, or a FIP sensor. For the FIP sensor, reference may be made to WO 2012/110924 A1, WO 2014/097181 A1, or WO 2016/120392 A1.

As further used herein, the term “optical detector” refers to an arbitrary device which comprises at least one optical sensor and at least one evaluation unit. As further used herein, the term “evaluation unit” generally relates to an arbitrary device which is configured to generate at least one item of information, in particular, about at least one property of the at least one substance by evaluating the at least one first sensor signal and the at least one second sensor signal. The evaluation unit may be or may comprise one or more integrated circuits, in particular at least one of an application-specific integrated circuit (ASIC), and/or a data processing device, in particular at least one of a digital signal processor (DSP), a field programmable gate arrays (FPGA), a microcontroller, a microcomputer, or a computer. Alternatively or in addition, the evaluation unit may, particularly, be or be comprised by at least one electronic communication unit, specifically a smartphone or a tablet. Additional components may be feasible, in particular one or more preprocessing devices and/or data acquisition devices, in particular one or more devices for receiving and/or preprocessing of the sensor signals, in particular one or more AD-converters and/or one or more filters. Further, the evaluation unit may comprise one or more data storage devices, in particular for storing at least one electronic table, in particular at least one look-up table. Further, the evaluation unit may comprise one or more interfaces, in particular one or more wireless interfaces and/or one or more wire-bound interfaces.

The evaluation unit may, preferably, be configured to perform at least one computer program, in particular at least one computer program performing or supporting the step of generating the at least one item of information. By way of example, one or more algorithms may be implemented, especially by using the at least one first sensor signal and the at least one second sensor signal as input variables, to perform a transformation into the at least one item of information. The evaluation unit may, particularly, comprise at least one data processing device, in particular an electronic data processing device, which can be designed to generate the at least one item of information by evaluating the at least one first sensor signal and the at least one second sensor signal. The evaluation unit is designed to use the at least one first sensor signal and the at least one second sensor signal as the input variables and to generate the at least one item of information by processing the input variables. In particular, Equation (1) as described above may be implemented for the purposes of the present invention. Herein, the processing can be performed in parallel, in a consecutive fashion or in a combined manner. The evaluation unit may use an arbitrary process for generating the at least one item of information, in particular by calculation and/or using at least one stored and/or known relationship.

In a particularly preferred embodiment, the substrate may be directly or indirectly applied to a circuit carrier device, such as a printed circuit board (PCB), wherein the circuit carrier device may comprise an opening, wherein the opening is configured to transmit the first illumination to the at least one first sensor layer. Herein, the term “directly” refers to an immediate attachment of the substrate to the circuit carrier device, whereas the term “indirectly” relates to an attachment of the substrate to the circuit carrier device via at least one intermediate layer, in particular, a bonding layer. As generally used, the term “printed circuit board”, usually abbreviated to “PCB”, refers to an electrically non-conductive, planar board, on which at least one sheet of an electrically conductive material, in particular a copper layer, is applied to, specifically laminated, onto the board. Other terms which refer to this type of circuit carrier device which, in addition, comprises one or more electronic, electrical, and/or optical elements may also be denoted as a printed circuit assembly, short “PCA”, a printed circuit board assembly, short “PCB assembly” or “PCBA”, circuit card assembly or short “CCA” or simply “card”. In the PCB, the board may comprise a glass epoxy, wherein a cotton paper impregnated with a phenolic resin, typically tan or brown, may also be used as the board material. Depending on a number of sheets, the printed circuit board may be a single-sided PCB, a two-layer or double-sided PCB, or a multi-layer PCB, wherein different sheets are connected with each other by using so-called “vias”. For the purposes of the present invention, an application of a single-sided PCB may be sufficient; however other kinds of printed circuit boards may also be applicable. A double-sided PCB may have metal on both sides while a multi-layer PCB may be designed by sandwiching additional metal layers between further layers of insulating material. In a multi-layer PCB, the layers can be laminated together in an alternating manner, wherein each metal layer may be individually etched and wherein internal vias may be plated through before the multiple layers are laminated together. Further, the vias may be or comprise copper-plated holes which can, preferably, be designed as electrically conducting paths through the insulating board. The substrate which carries the at last one sensor layer, the corresponding electrical contacts, and, if applicable, further layers may be placed onto the circuit carrier device, such as the PCB, specifically by gluing, soldering, welding, or otherwise depositing it directly or indirectly on an adjacent surface of the circuit carrier device. By way of example, the substrate may be attached to the circuit carrier device, such as the PCB, by a thin film of glue placed between adjacent surfaces of the substrate and of the circuit carrier device, such as the PCB. For further information, reference can be made https://en.wikipedia.org/wiki/Printed_circuit_board. Alternatively, other kinds of circuit carrier devices may, however, also be applicable.

In a particularly preferred embodiment, the at least one first sensor layer is or comprises at least one semi-transparent sensor layer. As used herein, the term “semi-transparent” refers to a property of the at least one first sensor layer to attenuate the first illumination. For this purpose, a share of the first illumination may be transmitted by the at least one first sensor layer or a portion thereof while a remaining share of the first illumination may be absorbed by the at least one first sensor layer or a portion thereof.

In a particularly preferred embodiment, the at least one semi-transparent sensor layer may, for this purpose, be or comprise a structured layer. As used herein, the term “structured layer” relates to a particular kind of layer which comprises at least one transparent portion and at least one intransparent portion. By structuring the at least one semi-transparent sensor layer, a relationship, especially a ratio, specifically a quotient, between a share of the first illumination which is transmitted through the at least one transparent portion and a remaining share of the first illumination which is absorbed by the at least one intransparent portion can be adjusted. The structured layer can be provided by removing a portion of the at least one first sensor layer as deposited on a substrate. Alternatively or in addition, at least one partial sensor layer, preferably a plurality of partial sensor layers, each having a size which does not completely cover the substrate can be deposited on the substrate. For further details of the semi-transparent sensor layer, reference can be made to the exemplary embodiments as provided below. Independently from the selected embodiment, the resulting semi-transparent sensor layer comprises the at least one transparent portion and the at least one intransparent portion. In this embodiment, the at least one semi-transparent sensor layer may, preferably, exhibit a thickness of 10 nm, of 20 nm, of 50 nm, of 100 nm, of 300 nm, to 1 μm, to 10 μm, to 50 μm, to 100 μm.

In an alternative embodiment, the at least one semi-transparent sensor layer can, for this purpose, be or comprise a sensor layer having a thickness which is designated to partially transmit the first illumination. Herein, at least one photoconductive material can be used. As indicated above, the photoconductive material which is capable of sustaining an electrical current, exhibits a specific electrical conductivity, wherein the electrical conductivity is further dependent on a thickness of a sensor layer. As well-known in physics, the electrical conductivity of the sensor layer comprising a photoconductive material increases with decreasing thickness of the sensor layer. As a result, by using a sensor layer having a reduced thickness, a grade of transmission of the first illumination via the layer of the photoconductive material can be increased. In this further embodiment, the at least one semi-transparent sensor layer may, preferably, have a thickness of 10 nm, of 20 nm, of 50 nm, of 100 nm, to 500 nm, to 1 μm, to 5 μm, to 10 μm.

In a further particularly preferred embodiment, the at least one first optical sensor and/or the at least one second optical sensor may further comprise a cover layer configured to cover accessible surfaces of the photoconductive material. Preferably, the cover layer may be designed to cover all accessible surfaces of the respective sensor layer, wherein it may be taken into account that the respective sensor layer may be deposited on a substrate which may already be adapted to protect a partition of the surfaces of the respective sensor layer. In addition, the cover may also fully or partially cover the electrical contacts, wherein the electrical contacts may be bonded to at least one external connection by using wire bonds. As a result, the substrate and the cover may cooperate in a fashion to accomplish a packaging, preferably an hermetic packaging, of the respective sensor layer, especially, in order to avoid a partial or full degradation of the photoconductive material by external influence, such as by humidity and/or by oxygen comprised in a surrounding atmosphere, as far as possible. For further details with respect to the cover layer, reference can be made to at least one of WO 2018/019921 A1 or WO 2020/148381 A1.

As already indicated above, the illumination is used to illuminate the at least one first sensor layer, the at least one second sensor layer, the sample comprising the at least one substance, or at least a portion thereof. As used herein, the term “illumination” refers to a partition of electromagnetic radiation, usually referred to as “light” which comprises the visible spectral range, the ultraviolet (UV) spectral range and the infrared (IR) spectral range. The term “ultraviolet spectral” relates to electromagnetic radiation having a wavelength of 1 nm to 380 nm, preferably of 100 nm to 380 nm, while the term “visible” refers to a wavelength of 380 nm to 760 nm. Further, the term “infrared” relates to a wavelength of 760 nm to 1000 μm, wherein a wavelength of 760 nm to 1 μm is, usually, denoted as “near infrared” or “NIR”, a wavelength of 1μ to 15 μm as “mid infrared” or “MidIR”, and a wavelength of 15 μm to 1000 μm as “far infrared” or “FIR”. For the present invention, in particular for gas sensing applications, illumination in the MidIR spectral range, preferably with a wavelength of 5 μm to 15 μm, may be used. The illumination may be emerging from at least one illumination source but can, alternatively or in addition, originate from the at least one substance itself.

In a preferred embodiment, the optical detector may comprise a single illumination source. The illumination source may be or comprise any type of illumination source which is known to provide sufficient emission in the IR spectral range, especially, in at least one of the NIR or the MidIR spectral ranges. In particular, the illumination source may be selected from at least one of: a thermal radiator, specifically an incandescent lamp or a thermal infrared emitter; an ambient light source, such as the sun; a flame source; a heat source; a laser, in particular a laser diode, although further types of lasers can also be used; a light emitting diode, in particular a light emitting diode having a phosphor converter or having a 2D material, such as molybdenum disulfide (MoS₂); an organic light source, in particular an organic light emitting diode; a neon light; a structured light source. Alternatively or in addition, other illumination sources may be used for the purposes of the present invention. As generally used, the term “incandescent lamp” relates to a device having a volume confined by a bulb, in particular of glass or fused quartz, wherein a wire filament, which may specifically comprise tungsten, emits the desired optical radiation. As further used herein, the term “thermal infrared emitter” refers to a micro-machined thermally-emitting device which comprises a radiation emitting surface configured to emits the desired optical radiation. Thermal infrared emitters are available as “emirs50” from Axetris AG, Schwarzenbergstrasse 10, CH-6056 Ksgiswil, Switzerland, as “thermal infrared emitters” from LASER COMPONENTS GmbH, Werner-von-Siemens-Str. 15 82140 Olching, Germany, or as “infra-red emitters” from Hawkeye Technologies, 181 Research Drive #8, Milford CT 06460, United States. However, further types of thermal infrared emitters may also be feasible.

In a further embodiment, the optical detector may comprise at least two individual illumination sources. Herein, the at least two individual illumination sources may, preferably, be identical or, as an alternative, differ from each other. Herein, the at least two individual illumination sources may, especially, be selected from the illumination sources as described above in more detail. In this further embodiment, it may be particularly preferred that the at least two individual illumination sources may be operated using a modulation, specifically a periodic modulation. Herein, the periodic modulations of the at least two individual illumination sources may, preferably, differ from each other. As generally used, the term “periodic modulation” relates to a consecutive alteration of the illumination between a maximum value and a minimum value of the total power of the illumination. Herein, the minimum value can be 0, but can also be >0, such that, by way of example, complete modulation does not have to be effected. The modulation can, preferably, be effected by modulating the at least one illumination source itself in order to generate the desired modulated illumination. For this purpose, the illumination source itself may provide a modulated intensity and/or total power, especially a periodically modulated total power, in particular by embodying a pulsed illumination source, specifically as a pulsed laser diode. Alternatively or in addition, a separate modulation device may be used, specifically a modulation device based on an electro-optical effect and/or an acousto-optical effect. Further, the evaluation device may, additionally, be configured to distinguish the at least two individual sensor signals in the case different modulation frequencies may be used.

In addition, the optical detector may comprise at least one optical filter. Preferably, the at least one optical filter may be placed in a path of the first illumination between the at least one illumination source and the at least one first optical sensor. As used herein, the term “optical filter” refers to an optical bandpass filter having a bandpass width, wherein only illumination having a wavelength which may, within a tolerance indicated by the bandpass width, is able to pass through the particular optical filter. In the above-described embodiment in which at least two individual illumination sources may be present, an individual optical filter may be placed in the path of the first illumination between each individual illumination source and the at least one first optical sensor. Herein, each individual optical filter may, preferably, differ from each other. In this embodiment, in which at least two individual illumination sources may be present, each individual illumination source may comprise the same type of illumination source but can be operated with a different modulation frequency and/or the generated first illumination may be guided to a different optical filter.

This particular embodiment which comprises at least two individual illumination sources may, especially, be used for multi-gas sensing. Herein, the share of the first illumination comprising a particular wavelength or wavelength range can be provided to every gas species in order to be filtered by at least one corresponding absorption band of each gas species. By using the modulation of each individual illumination source at a different modulation frequency, the sensor signals can be assigned to each gas species and, therefore, be separated for both the at least one first optical sensor and the at least one second optical sensor, in particular, by using a Fast Fourier Transformation (FFT) as well-known to the skilled person. However, other ways of evaluating the sensor signals which may originate from one of the different illumination sources may also be feasible.

In a further aspect of the present invention, a method for determining at least one property of at least one substance is disclosed. The method comprises the following steps a) to d), which may be performed in the given order, however a different order may be possible in part. Further, additional method steps might be provided which are not listed. Unless explicitly indicated otherwise, two or more or even all of the method steps might be performed simultaneously, at least partially. Further, two or more or even all of the method steps might be performed twice or even more than twice, repeatedly.

The method for determining at least one property of at least one substance comprises the following steps:
a) providing an optical detector according to any one of the preceding claims;
b) introducing the at least one substance in a volume located between at least one first optical sensor and at least one second optical sensor designated for receiving the at least one substance, wherein the at least one first optical sensor is configured to transmit a share of a first illumination into the volume for analyzing the at least one substance;
c) guiding the share of the first illumination into the volume for analyzing the at least one substance in a manner that the share of the first illumination passes the at least one first optical sensor, subsequently travels through the volume comprising the at least one substance, whereby it is modified into a second illumination which subsequently impinges on the at least one second optical sensor; and
d) determining at least one property of the at least one substance from at least one first sensor signal depending on the first illumination of at least one first sensor layer as comprised by the at least one first optical sensor and at least one second sensor signal depending on the second illumination of at least one second sensor layer as comprised by the at least one second optical sensor.

According to step a), an optical detector as described above or below in more detail herein is provided.

According to step b), the at least one substance to be analyzed is introduced into a volume which is located between at least one first optical sensor and at least one second optical sensor, wherein the volume is designated for receiving the at least one substance. Herein, the at least one first optical sensor is configured to transmit a share of the first illumination into the volume for analyzing the at least one substance.

According to step c), the share of the first illumination is guided into the volume for analyzing the at least one substance. For this purpose, the share of the first illumination passes the at least one first optical sensor, subsequently passes the volume comprising the at least one substance, whereby it is modified into a second illumination which subsequently impinges on the at least one second optical sensor.

According to step d), at least one property of at least one substance is determined from at least one first sensor signal which depends on an illumination of at least one first sensor layer which is comprised by the at least one first optical sensor and at least one second sensor signal which depends on an illumination of at least one second sensor layer that is comprised by the at least one second optical sensor.

The method may, preferably, may be used for operating at the least one optical detector according to the present invention, such as the at least one optical detector according to any embodiment as disclosed in this document. For further details and optional embodiments of the method, reference may be made to the description of the optical detector and the various embodiments thereof.

In a further aspect of the present invention, a use of a detector according to the present invention is disclosed. Therein, a use of the detector for a purpose of use is selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application such as characterization of soil, silage, feed, crop or produce, monitoring plant health; a plastics identification and/or recycling application; a pressure control application. However, further uses may still be conceivable.

The above-described optical detector and method for determining at least one property of at least one substance have considerable advantages over the prior art. Firstly, they allow a direct measurement of the intensity I₀ of the first illumination before interacting with the sample, whereby only a relationship, especially a ratio, specifically a quotient, between a share of the incident illumination which is transmitted through the at least one transparent portion of the at least one first optical sensor and a remaining share of the incident illumination which is absorbed by the at least one intransparent portion of the at least one second optical sensor may be taken into account. Further, a single optical filter may be preferred, wherein the single optical filter may, especially, be used for at least one corresponding absorption band of the substance to be analyzed. In addition, the present optical detector may also be applicable to multi-gas sensing, especially by using at least two individual optical filters, preferably in connection with differently modulated illumination sources as described below in more detail. Further, no additional optical transfer elements, such as optical beam-splitters, are required to illuminate the sensor layers of both kinds optical sensors, i.e. the at least one reference sensor and the at least one measurement sensor. As an advantage, an optical stability of the optical detector may be less affected by spectral radiation shifts resulting from the IR illumination source. As a further advantage, an amount of required space can be minimized, in particular, since both kinds optical sensors can be provided as planes which are, already, used as boundaries for the volume designated for receiving the sample. In addition, further advantages may be conceivable.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restriction regarding the scope of the invention and without any restriction regarding the possibility of combining the features introduced in such a way with other optional or non-optional features of the invention.

Summarizing, in the context of the present invention, the following embodiments are regarded as particularly preferred:

Embodiment 1: An optical detector for determining at least one property of at least one substance, comprising:
at least one first optical sensor comprising at least one first sensor layer, wherein the at least one first optical sensor is configured to generate at least one first sensor signal depending on a first illumination illuminating at least a portion of the at least one first sensor layer;
at least one second optical sensor comprising at least one second sensor layer, wherein the at least one second optical sensor is configured to generate at least one second sensor signal depending on a second illumination illuminating at least a portion of the at least one second sensor layer;

wherein the at least one first optical sensor and the at least one second optical sensor are spaced apart from each other in a manner that a volume between the at least one first optical sensor and the at least one second optical sensor is designated for receiving at least one substance, wherein the at least one first optical sensor is configured to transmit a share of the first illumination into the volume; and
at least one evaluation unit configured to generate at least one item of information about
at least one property of the at least one substance by evaluating the at least one first sensor signal and the at least one second sensor signal.

Embodiment 2: The optical detector according to the preceding Embodiment, wherein the at least one first sensor layer is or comprises at least one semi-transparent sensor layer.

Embodiment 3: The optical detector according to the preceding Embodiment, wherein the at least one semi-transparent sensor layer has a thickness capable of transmitting the share of the first illumination into the volume.

Embodiment 4: The optical detector according to any one of the two preceding Embodiments, wherein the at least one semi-transparent sensor layer is or comprises a structured layer.

Embodiment 5: The optical detector according to the preceding Embodiment, wherein the structured layer comprises at least one transparent portion and at least one intransparent portion.

Embodiment 6: The optical detector according to the preceding Embodiment, wherein the at least one transparent portion and the at least one intransparent portion are located on a transparent substrate.

Embodiment 7: The optical detector according to the preceding Embodiment, wherein the at least one transparent portion and the at least one intransparent portion are located on a transparent substrate in an alternating manner.

Embodiment 8: The optical detector according to any one of the preceding Embodiments, wherein the at least one first sensor layer comprises at least one layer of at least one photoconductive material.

Embodiment 9: The optical detector according to the preceding Embodiment, wherein the at least one photoconductive material comprises at least one chalcogenide, wherein the at least one chalcogenide is selected from the group consisting of a sulfide chalcogenide, a selenide chalcogenide, a telluride chalcogenide, a ternary chalcogenide, a quaternary chalcogenide, a higher chalcogenide, and a solid solution and/or a doped variant thereof.

Embodiment 10: The optical detector according to the preceding Embodiment, wherein the chalcogenide is selected from the group consisting of lead sulfide (PbS), copper indium sulfide (CIS), copper indium gallium selenide (CIGS), copper zinc tin sulfide (CZTS), lead selenide (PbSe), copper zinc tin selenide (CZTSe), cadmium telluride (CdTe), mercury cadmium telluride (HgCdTe), mercury zinc telluride (HgZnTe), lead sulfoselenide (PbSSe), copper-zinc-tin sulfur-selenium chalcogenide (CZTSSe), molybdenum disulfide (MoS₂), and a solid solution and/or a doped variant thereof.

Embodiment 11: The optical detector according to any one of the preceding Embodiments, further comprising at least one illumination source.

Embodiment 12: The optical detector according to any one of the preceding Embodiments, further comprising at least one optical filter.

Embodiment 13: The optical detector according to any one of the preceding Embodiments, further comprising at least two individual illumination sources.

Embodiment 14: The optical detector according to the preceding Embodiment, wherein each illumination source differs from each other by a periodic modulation of the first illumination as generated by each illumination source.

Embodiment 15: The optical detector according to any one of the two preceding Embodiments, further comprising at least two individual optical filters.

Embodiment 16: The optical detector according to the preceding Embodiment, wherein each optical filter is configured to pass a different wavelength or wavelength range of the first illumination as generated by each illumination source.

Embodiment 17: The optical detector according to any one of the preceding Embodiments, comprising a circuit carrier device designed to carry the at least one first optical sensor.

Embodiment 18: The optical detector according to the preceding Embodiment, wherein the circuit carrier device is a printed circuit board (PCB).

Embodiment 19: The optical detector according to any one of the two preceding Embodiments, wherein the circuit carrier device comprises an opening, wherein the opening is configured to transmit the first illumination to the at least one first sensor layer.

Embodiment 20: The optical detector according to any one of the preceding Embodiments, wherein the optical detector is configured to detect at least one wavelength in at least a partition of the infrared spectral range, the infrared spectral range ranging from 760 nm to 1000 μm.

Embodiment 21: The optical detector according to the preceding Embodiment, wherein the optical detector is configured to detect at least one wavelength in at least a partition of the near infrared spectral range, the near infrared spectral range ranging from 760 nm to 1 μm, or the mid infrared spectral range, the near infrared spectral range ranging from 1μ to 15 μm.

Embodiment 22: The optical detector according to the preceding Embodiment, wherein the optical detector is configured to detect at least one wavelength of 5 μm to 15 μm.

Embodiment 23: A method for determining at least one property of at least one substance, the method comprising the following steps:
a) providing an optical detector according to any one of the preceding Embodiments;
b) introducing the at least one substance in a volume located between at least one first optical sensor and at least one second optical sensor designated for receiving the at least one substance, wherein the at least one first optical sensor is configured to transmit a share of a first illumination into the volume for analyzing the at least one substance;
c) guiding the share of the first illumination into the volume for analyzing the at least one substance in a manner that the share of the first illumination passes the at least one first optical sensor, subsequently travels through the volume comprising the at least one substance, whereby it is modified into a second illumination which subsequently impinges on the at least one second optical sensor; and
d) determining at least one property of the at least one substance from at least one first sensor signal depending on the first illumination of at least one first sensor layer as comprised by the at least one first optical sensor and at least one second sensor signal depending on the second illumination of at least one second sensor layer as comprised by the at least one second optical sensor.

Embodiment 24: The method according to the preceding Embodiment, wherein the at least one property of the at least one substance is selected from at least one of an extinction coefficient c and a concentration c of the at least one substance introduced in the volume.

Embodiment 25: The method according to any one of the two preceding Embodiments, wherein the at least one first sensor layer is or comprises at least one semi-transparent sensor layer.

Embodiment 26: The method according to the preceding Embodiment, wherein the at least one semi-transparent sensor layer is or comprises a structured layer.

Embodiment 27: The method according to the preceding Embodiment, wherein the structured layer comprises at least one transparent portion and at least one intransparent portion.

Embodiment 28: The method according to the preceding Embodiment, wherein step c) is performed in a manner that the share of first illumination as guided into the volume only passes the at least one transparent portion of the at least one first optical sensor.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 schematically illustrates a preferred exemplary embodiment of an optical detector for determining at least one property of at least one substance according to the present invention;

FIG. 2 schematically illustrates an optical detector for determining at least one property of at least one substance as known from prior art;

FIG. 3 schematically illustrates a preferred exemplary arrangement of a first optical sensor within the optical detector for determining at least one property of at least one substance according to the present invention;

FIGS. 4A to 4F each schematically illustrates a preferred exemplary embodiment of a first sensor layer as comprised by the first optical sensor;

FIG. 5 schematically illustrates a further preferred exemplary embodiment of the optical detector for determining at least one property of at least one substance according to the present invention; and

FIG. 6 schematically illustrates a preferred exemplary embodiment of a method for determining at least one property of at least one substance according to the present invention.

### EXEMPLARY EMBODIMENTS

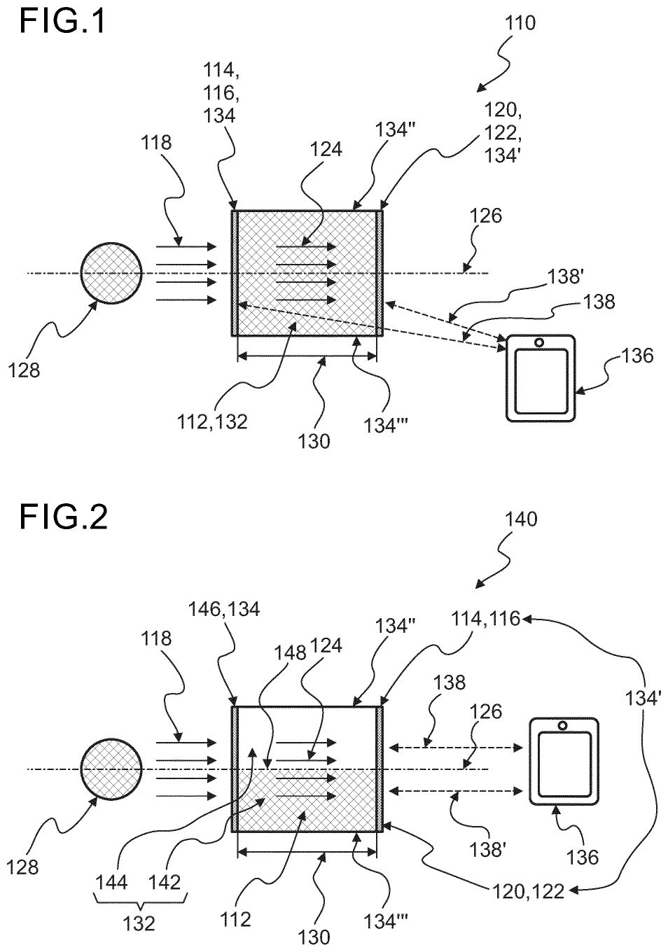

FIG. 1 illustrates, in a highly schematic fashion, an exemplary embodiment of an optical detector 110 for determining at least one property of at least one substance 112 according to the present invention in a schematic top view. For this purpose, the optical detector 110 may, as a preference, be designed as an infrared detector, in particular for the MidIR spectral range, especially for gas sensing applications for a wavelength of 5 μm to 15 μm. However, the optical detector 110 may also be designated for other wavelengths.

Accordingly, the optical detector 110 comprises a first optical sensor 114 which has a first sensor layer 116. Herein, the first optical sensor 114 is configured to generate at least one first sensor signal depending on an illumination 118 of the first sensor layer 116 or at least a portion of thereof. Further, the optical detector 110 comprises a second optical sensor 120 which has a second sensor layer 122. Herein, the second optical sensor 120 is configured to generate at least one second sensor signal depending on the illumination 124 of the second sensor layer 122 or at least a portion of thereof. As schematically depicted in FIG. 1, the first optical sensor 114 and the second optical sensor 120 may be arranged in form of a stack as defined above along an optical axis 126 of the optical detector 110. Specifically, the optical axis 126 may be an axis of symmetry and/or rotation of an arrangement of the optical detector 110.

As schematically illustrated in FIG. 1, the illumination 118 may be provided by an illumination source 128. As already described above in more detail, the illumination source 128 may be or comprise any type of light source which is known to provide sufficient emission in the IR spectral range, especially the NIR and/or the MidIR spectral ranges, preferably a wavelength of 1 μm to 5 μm, in particular of 1 μm to 3 μm. Herein, the illumination source 128 may be selected from at least one of: a thermal radiator, specifically an incandescent lamp or a thermal infrared emitter; an ambient light source, such as the sun; a flame source; a heat source; a laser, in particular a laser diode, although further types of lasers can also be used; a light emitting diode, in particular a light emitting diode having a phosphor converter or having a 2D material, such as molybdenum disulfide (MoS₂); an organic light source, in particular an organic light emitting diode; a neon light; a structured light source. However, a further type of illumination source 128 may also be feasible.

As further schematically illustrated in FIG. 1, the first optical sensor 114 and the second optical sensor 120 are spaced apart from each other by a distance 130. As a result of this particular arrangement, a volume 132 is generated between the first optical sensor 114 and the second optical sensor 120 which is designated for receiving the at least one substance 112.

Preferably, the first optical sensor 114 and the second optical sensor 120 may be arranged in form of a fixed mechanical connection in a fashion that a cube shape may be obtained. In a preferred embodiment, the volume 132 may, further, act as a receptacle for a cuvette (not depicted here) which is designed for accommodating a liquid sample comprising the at least one substance 112. Herein, the cuvette may, specifically, comprise walls having spatial dimensions which allow inserting the cuvette into the volume 132. As further illustrated there, the exemplary cube-shaped volume 132 as viewed from above, is confined by four boundaries 134, 134′, 134″, 134′″, wherein, as depicted, the two opposing boundaries 134, 134′ are formed by the first optical sensor 114 and the second optical sensor 120, wherein, as described above or below in more detail, the boundary 134 which is formed by the first optical sensor 114 is a semi-transparent boundary which enables a portion of the illumination 118 to pass through the first optical sensor 114 in order to, subsequently, interact with the at least one substance 112 in the volume 132.

In this fashion, the at least one property of the at least one substance 112 can be determined by using the well-known Beer-Lambert Law according to Equation (1),

I₁=I₀·e^{-εcd}. (1)

Accordingly, the first optical sensor 114 is designated to determine, at a given wavelength, an intensity I₀ of the illumination 118 before interacting with the at least one substance 112 while the second optical sensor 120 is designated to determine, at a given wavelength, an intensity I₁ of the illumination 124 after interacting with the at least one substance 112. Further, d denotes the distance 130 between the first optical sensor 114 and the second optical sensor 120 which corresponds to a length of a path of the illumination 124 which may pass through the volume 132. Herein, the distance d may, respectively, be decreased by the walls of a cuvette. Further, each of c and c denote a quantity which is related to a property of the at least one substance 112, i.e. an extinction coefficient ε and a concentration c. Since the length d of the path of the illumination 124 which passes through the volume 132 is known in general, a product of the two quantities, i.e. the extinction coefficient ε of the at least one substance 112 and the concentration c of the at least one substance 112 in the volume 132, can be determined. As an alternative, the extinction coefficient ε of the at least one substance 112 or the concentration c of the at least one substance 112 within the volume 132 can be determined if the other quantity is known.

As further schematically illustrated in FIG. 1, the optical detector 110 comprises an evaluation unit 136 which is configured to generate at least one item of information about the at least one property of the at least one substance 112. For this purpose, the at least one first sensor signal and the at least one second sensor signal are transmitted via electrical connections 138, 138′ in a wireless or a wire-bound fashion to the evaluation unit 136, which is schematically depicted in FIG. 1 as a smartphone. However, as described above in more detail, the evaluation unit 136 may comprise one or more electronic devices and/or one or more software components, in order to evaluate the sensor signals from the at least one first sensor signal and the at least one second sensor signal.

In further accordance with the present invention, the first optical sensor 114 is configured to partially transmit the illumination 118 into the volume 132, in particular, in order to enable a subsequent illumination 124 of the at least one substance 112 as located within the volume 132 and of the second optical sensor 120. This feature is in particular contrast to a prior art optical detector 140 for determining the at least one property of the at least one substance 112, which is illustrated in FIG. 2 in a comparable schematic top view.

As depicted in FIG. 2, only a first partial volume 142 of the volume 132 can be used here to accommodate the at least one substance 112 while a second partial volume 144 of the volume 132 has to maintained free from the at least one substance 112 in order to be able to transmit the illumination 118 before interacting with the at least one substance 112 to the first optical sensor 114 which is, as indicated above, designated to determine the intensity I₀ of the illumination 118 before interacting with the at least one substance 112. As a result of this arrangement, only the first partial volume 142 can be used in the prior art optical detector 140 for determining the at least one property of the at least one substance 112, while the second partial volume 144 can be considered as wasted space.

In addition, only the boundary 134′ of the four boundaries 134, 134′, 134″, 134′″ which form the cube-shaped volume 132 of the prior art optical detector 140 as viewed from above can be formed by a combination of the first optical sensor 114 and the second optical sensor 120 arranged in line, wherein, as depicted in FIG. 2, the opposing boundary 134 is required to be formed by an additional window 146. Only this particular arrangement allows the illumination 118 to pass through the additional window 146, on one hand, to directly impinge on the first optical sensor 114 after passing the first partial volume 142 and, on the other hand, to interact with the at least one substance 112 in the second partial volume 144 prior to impinging on the second optical sensor 120. In addition, an additional boundary 148 between the first partial volume 142 and the second partial volume 144 may be required, especially in a typical case in which the at least one substance 112 may comprises a liquid or a gaseous composition. Herein, the additional boundary 148 may be provided by a walls of a cuvette. As a result, the optical detector 110 according to the present invention has various advantages compared to the prior art optical detector 140.

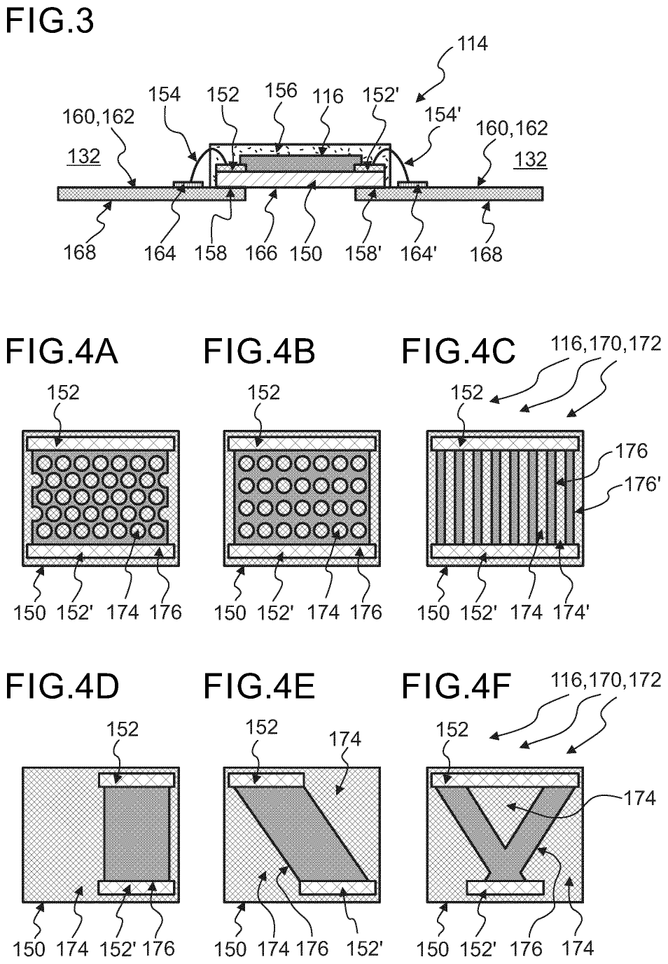

FIG. 3 schematically illustrates a preferred exemplary arrangement of the first optical sensor 114 within the optical detector 110 according to the present invention. As already indicated above, the first optical sensor 114 comprises the sensor layer 116 which enables the first optical sensor 114 to generate the at least one first sensor signal depending on the illumination 118 of the first sensor layer 116 or at least a portion of thereof. As depicted in FIG. 3, the sensor layer 116 is directly applied to a substrate 150, wherein the substrate 150 may, preferably, be or comprise an insulating substrate. However, an indirect application may also be feasible, in particular by inserting an additional layer, especially a bonding layer (not depicted here), between the substrate 150 and the first sensor layer 116. The first sensor layer 116 may, preferably, comprise at least one photoconductive material. Herein, the photoconductive material may be or comprise at least one chalcogenide, preferably, selected from a group comprising sulfide chalcogenides, selenide chalcogenides, telluride chalcogenides, and ternary chalcogenides. In particular, the photoconductive material may be or comprise a sulfide, preferably lead sulfide (PbS), a selenide, preferably lead selenide (PbSe), or a ternary chalcogenide, preferably lead sulfoselenide (PbSSe). However, other kinds of photoconductive materials, in particular the photoconductive materials as indicated above, may also be feasible.

As further illustrated in FIG. 3, the first optical sensor 114 may, preferably, comprise at least two individual electrical contacts 152, 152′, wherein each electrical contact 152, 152′ is designed to provide a respective electrical contact to the first sensor layer 116. For this purpose, the electrical contacts 152, 152′ may be designed and arranged in a manner to guide an electrical current via one of the electrical contacts 152 through the first sensor layer 116 to the other electrical contact 152′, or vice-versa, or to apply a voltage across the first sensor layer 116 by using the electrical contacts 152, 152′. Herein, the electrical contacts 152, 152′ may be electrically isolated from each other while both electrical contacts 152, 152′ directly connect the first sensor layer 116. As further depicted in FIG. 3, the electrical contacts 152, 152′ may, especially, be connected to an external circuit by corresponding wire bonds 154, 154′.

As further illustrated in FIG. 3, the first optical sensor 114 may, preferably, comprise a cover 156, wherein the cover 156 may at least partially, preferably fully, cover all accessible surfaces of the first sensor layer 116. In particular, the cover 156 may be designated to provide an encapsulation for the photoconductive material as comprised by the first sensor layer 116, in particular, as an hermetic package, in order to avoid a degradation of the photoconductive material, especially by external influence, such as humidity and/or oxygen. As schematically depicted in FIG. 3, the cover 156 may, preferably fully, cover all accessible surfaces of the first sensor layer 116 and of the substrate 150, respectively. In particular, the cover 156 may directly contact top and sides of the sensor layer 116 as well as the sides of the substrate 124. As a result, the cover 156 may prevent a direct contact between the first sensor layer 116 with an atmosphere surrounding the first optical sensor 114, thereby avoiding the degradation of the photoconductive material as comprised by the first sensor layer 116.

As further illustrated in FIG. 3, the substrate 150 may, preferably, be attached, specifically via a thin film 158, 158′ of adhesive, to a circuit carrier device 160, in particular to a printed circuit board (PCB) 162. For this purpose, the wire bonds 154, 154′, may be configured to bond the electrical contacts 152, 152′ to contact pads 164, 164′ being located on a surface of the circuit carrier device 160, the surface facing the electrical contacts 152, 152′. In the particularly preferred embodiment as illustrated in FIG. 3, the electrical contacts 152, 152′ are bondable through the cover 156. This feature may, in particular, improve the encapsulation function of the cover 156 and, concurrently, provide stability to the electrical contacts 152, 152′.

To transmit the illumination 118 to the photoconductive material as comprised by the first sensor layer 116, at last one of the cover 116 or the substrate 124 is optically transparent within a desired wavelength range, such as described above. As further depicted in FIG. 3, the circuit carrier device 160, in particular the printed circuit board (PCB) 162, may comprise an opening 166. In the exemplary arrangement as illustrated there, the opening 166 may be designed for receiving the illumination 118 and for guiding the illumination 118 via the optically transparent substrate 150 to the first sensor layer 116. Herein, a rear side 168 of the circuit carrier device 160, in particular the printed circuit board (PCB) 162, may be arranged in a fashion that it may contribute to protecting the volume 132 from a surrounding atmosphere.

For further details with respect to the first optical sensor 114 or any components thereof, in particular the substrate 150, the photoconductive material, the cover 156, the electrical contacts 152, 152′, the wire bonds 154, 154′, or the circuit carrier 160, specifically the printed circuit board 162, reference may be made to at least one of WO 2016/120392 A1, WO 2018/019921 A1, WO 2018/077870 A1, or WO 2020/148381.

Further, it is indicated here that the second optical sensor 120 may be arranged in a similar fashion as the first optical sensor 114, especially as depicted in FIG. 3, in particular, in an embodiment in which it is desired that the first optical sensor 114 may be a partially transparent optical sensor. Alternatively, the second optical sensor 120 can, be an in transparent optical sensor. In this particular embodiment, the second optical sensor 120 may be or comprise a further photosensitive element, particularly, selected from a CCD chip, a CMOS chip, a pyroelectric element, a bolometric element, a thermopile element, or a FIP sensor.

FIGS. 4A to 4F each schematically illustrates a preferred exemplary embodiment of the first sensor layer 116 as comprised by the first optical sensor 114. As illustrated there, the first sensor layer 116 may be or comprise a semi-transparent sensor layer 170 which is designed to attenuate the illumination 118. For this purpose, the semi-transparent sensor layer 170 may be arranged in a fashion that a share of the illumination 118 may be transmitted by the semi-transparent sensor layer 170 while a remaining share of the illumination 118 may be absorbed by the semi-transparent sensor layer 170.

As depicted in FIGS. 4A to 4F, the semi-transparent sensor layer 170 may, for this purpose, be or comprise a structured layer 172, wherein the structured layer 172 comprises at least one transparent portion 174, 174′, . . . and at least one intransparent portion 176, 176′, . . . , each located on the substrate 150. The exemplary embodiments as illustrated in FIGS. 4A to 4F differ with respect to each other by at least one of an arrangement, an orientation, or an area of the respective transparent portions 174, 174′, . . . and the corresponding intransparent portions 176, 176′ . . . . However, further exemplary embodiments may also be conceivable.

By structuring the semi-transparent sensor layer 170, a relationship, especially a ratio, specifically a quotient, between the share of the illumination 118 being transmitted through the at least one transparent portion 174, 174′, . . . and the remaining share of the illumination 118 being absorbed by the at least one intransparent portion 176, 176′, . . . can be adjusted. The structured layer 172 can be provided by removing a portion of the at least one first sensor layer 116 as deposited on a substrate. Alternatively or in addition, at least one partial sensor layer which has a size that does not completely cover the substrate 150 can be deposited on the substrate 150, thereby generating the at least one transparent portion 174, 174′, . . . and the at least one intransparent portion 176, 176′, . . . .

In an alternative embodiment, the first sensor layer 116, such as depicted in FIG. 3, can be the semi-transparent sensor layer 170 by having a reduced thickness which is designated to partially transmit the illumination 118. As indicated above in more detail, a photoconductive material can be used for this purpose. As a result, a grade of transmission of the illumination 118 via the layer of the photoconductive material can be increased.

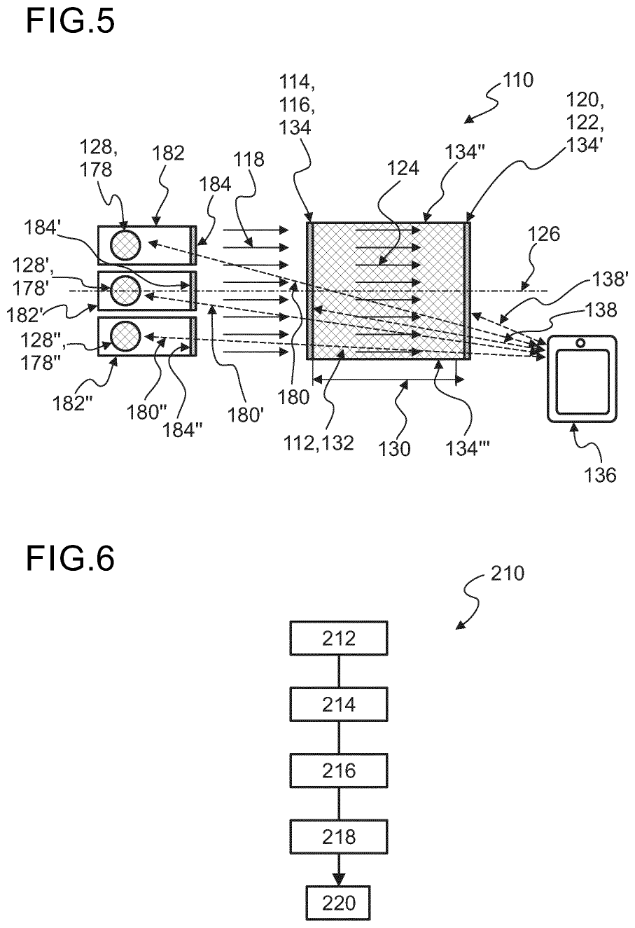

FIG. 5 schematically illustrates a further preferred exemplary embodiment of the optical detector 110 according to the present invention. As depicted there, this further embodiment of the optical detector 110 differs from the embodiment of the optical detector 110 as illustrated in FIG. 1, in particular, by using a plurality of illumination sources 128, 128′, 128″. Herein, each illumination source 128, 128′, 128″ may, preferably, be identical but may be operated by using a different kind of periodic modulation 178, 178′, 178″, wherein the periodic modulations, in particular, 178, 178′, 178″ differ from each other by a different modulation frequency. Herein, the periodic modulation can, preferably, be effected by modulating each illumination source 128, 128′, 128″ in order to generate the desired modulated, especially with respect to a periodically modulated total power of each illumination source 128, 128′, 128″. For this purpose, each illumination source 128, 128′, 128″ may, specifically, be or comprise a pulsed illumination source, specifically as a pulsed laser diode.

As further depicted in FIG. 5, the evaluation device 136 may, additionally, be configured, on one hand, to effect, in particular via further electrical connections 180, 180′, 180″ in a wireless or a wire-bound fashion, the modulating of each illumination source 128, 128′, 128″ and, on the other hand, to distinguish the different sensor signals from each illumination source 128, 128′, 128″ by using their respectively different modulation frequencies, in particular, by applying a Fast Fourier Transformation (FFT).

As further illustrated in FIG. 5, each illumination source 128, 128′, 128″ may comprise a housing 182, 182′, 182″, in particular, to minimize stray light in order to guide more of the first illumination 118 as generated by each illumination source 128, 128′, 128″ to the first optical sensor 114. As further depicted there, an optical filter 184, 184′, 184″ may, preferably, be placed between an output of each illumination source 128, 128′, 128″ and the first optical sensor 114. Herein, the optical filters 184, 184′, 184″ may, as particularly preferred, be different from each other. Although each illumination source 128, 128′, 128″ may, in this particular embodiment, comprise the same type of illumination source, the generated first illumination 118 may differ from each other not only by a different periodic modulation 178, 178′, 178″ but also by a different wavelength or wavelength range as a result of the first illumination 118 as generated by each illumination source 128, 128′, 128″ passing the different optical filters 184, 184′, 184″. This particular embodiment can, in particular, be used for multi-gas sensing, especially, by providing illumination having a particular wavelength or wavelength range to every gas species, wherein the particular wavelength or wavelength range may, preferably, correspond to at least one absorption band of each gas species.

FIG. 6 schematically illustrates a preferred exemplary embodiment of a method 210 for determining at least one property of the at least one substance 112 according to the present invention.

In a providing step 212 according to step a), the optical detector 110 as described above is provided.

In an introducing step 214 according to step b), the at least one substance 112 is introduced into the volume 132 located between the first optical sensor 114 and the second optical sensor 120, wherein the volume 132 is designated for receiving the at least one substance 112. As already described above, the first optical sensor 114 is configured to partially transmit the illumination 118 into the volume 132 for analyzing the at least one substance 112.

In a guiding step 216 according to step c), the illumination 118 is guided into the volume 132 for analyzing the at least one substance 112 in a fashion that the illumination 118 passes the first optical sensor 114, subsequently passes the volume 132 which comprises the at least one substance 112, whereby the illumination 118 is modified into the illumination 124, which subsequently impinges on the second optical sensor 120.

In a determining step 218 according to step d), at least one property 220 of the at least one substance 112 is determined from the at least one first sensor signal depending on the illumination 118 of the first sensor layer 116 as comprised by the first optical sensor 114 and at least one second sensor signal depending on the illumination 124 of the second sensor layer 122 as comprised by the second optical sensor 120. For this purpose, the evaluation unit 136 as described above in more detail may, preferably be used.

### LIST OF REFERENCE NUMBERS

110 optical detector
112 substance
114 first optical sensor
116 first sensor layer
118 first illumination
120 second optical sensor
122 second sensor layer
124 second illumination
126 optical axis
128, 128′, . . . illumination source
130 distance
132 volume
134, 134′, . . . boundary
136 evaluation unit
138, 138′ electrical connection
140 prior art optical detector
142 first partial volume
144 second partial volume
146 additional window
148 additional boundary
150 substrate
152, 152′ electrical contact
154, 154′ wire bond
156 cover
158 film (of adhesive)
160 circuit carrier device
162 printed circuit board
164, 164′ contact pad
166 opening
168 rear side
170 semi-transparent sensor layer
172 structured layer
174, 174′ . . . transparent portion
176, 176′ . . . intransparent portion
178, 178′, . . . periodic modulation
180, 180′, . . . further electrical connection
182, 182′, . . . housing
184, 184′, . . . optical filter
210 method for determining at least one property of at least one substance
212 providing step
214 introducing step
216 guiding step
218 determining step
220 property (of the at least one substance)

1. An optical detector for determining at least one property of at least one substance, comprising:
at least one first optical sensor comprising at least one first sensor layer, wherein the at least one first optical sensor is configured to generate at least one first sensor signal depending on a first illumination illuminating at least a portion of the at least one first sensor layer;
at least one second optical sensor comprising at least one second sensor layer, wherein the at least one second optical sensor is configured to generate at least one second sensor signal depending on a second illumination illuminating at least a portion of the at least one second sensor layer;
wherein the at least one first optical sensor and the at least one second optical sensor are spaced apart from each other in a manner that a volume between the at least one first optical sensor and the at least one second optical sensor is designated for receiving at least one substance, wherein the at least one first optical sensor is configured to transmit a share of the first illumination into the volume;
at least two individual illumination sources, wherein each illumination source differs from each other by a periodic modulation of the first illumination as generated by each illumination source; and
at least one evaluation unit configured to generate at least one item of information about at least one property of the at least one substance by evaluating the at least one first sensor signal and the at least one second sensor signal.

2. The optical detector according to claim 1, wherein the at least one first sensor layer is or comprises at least one semi-transparent sensor layer.

3. The optical detector according to claim 1, wherein the at least one semi-transparent sensor layer has a thickness capable of transmitting the share of the first illumination into the volume.

4. The optical detector according to claim 1, wherein the at least one semi-transparent sensor layer is or comprises a structured layer, wherein the structured layer comprises at least one transparent portion and at least one intransparent portion.

5. The optical detector according to claim 1, wherein the at least one transparent portion and the at least one intransparent portion are located on a transparent substrate in an alternating manner.

6. The optical detector according to claim 1, wherein the at least one first sensor layer comprises at least one layer of at least one photoconductive material.

7. The optical detector according to claim 1, wherein the at least one photoconductive material comprises at least one chalcogenide, wherein the at least one chalcogenide is selected from the group consisting of a sulfide chalcogenide, a selenide chalcogenide, a telluride chalcogenide, a ternary chalcogenide, a quaternary chalcogenide, a higher chalcogenide, and a solid solution and/or a doped variant thereof.

8. The optical detector according to claim 7, wherein the chalcogenide is selected from the group consisting of lead sulfide (PbS), copper indium sulfide (CIS), copper indium gallium selenide (CIGS), copper zinc tin sulfide (CZTS), lead selenide (PbSe), copper zinc tin selenide (CZTSe), cadmium telluride (CdTe), mercury cadmium telluride (HgCdTe), mercury zinc telluride (HgZnTe), lead sulfoselenide (PbSSe), copper-zinc-tin sulfur-selenium chalcogenide (CZTSSe), molybdenum disulfide (MoS₂), and a solid solution and/or a doped variant thereof.

9. The optical detector according to claim 1, wherein each periodic modulation 8, has a different modulation frequency assigned to a particular gas species, thereby separating the at least one first sensor signal for the at least one first optical sensor from the at least one second sensor signal for the at least one second optical sensor.

10. The optical detector according to claim 1, further comprising at least two individual optical filters, wherein each optical filter is configured to pass a different wavelength or wavelength range of the first illumination as generated by each illumination source.

11. The optical detector according to claim 1, comprising a circuit carrier device designed to carry the at least one first optical sensor, wherein the circuit carrier device comprises an opening, wherein the opening is configured to transmit the first illumination to the at least one first sensor layer.

12. The optical detector according to claim 1, wherein the optical detector is configured to detect at least one wavelength in at least a partition of the infrared spectral range, the infrared spectral range ranging from 760 nm to 1000 μm.

13. A method for determining at least one property of at least one substance, the method comprising the following steps:
a) providing an optical detector according to claim 1;
b) introducing the at least one substance in a volume located between at least one first optical sensor and at least one second optical sensor designated for receiving the at least one substance, wherein the at least one first optical sensor is configured to transmit a share of a first illumination into the volume for analyzing the at least one substance;
c) guiding the share of the first illumination into the volume for analyzing the at least one substance in a manner that the share of the first illumination passes the at least one first optical sensor, subsequently travels through the volume comprising the at least one substance, whereby it is modified into a second illumination which subsequently impinges on the at least one second optical sensor; and
d) determining at least one property of the at least one substance from at least one first sensor signal depending on the first illumination of at least one first sensor layer as comprised by the at least one first optical sensor and at least one second sensor signal depending on the second illumination of at least one second sensor layer as comprised by the at least one second optical sensor.

14. The method according to claim 1, wherein the at least one property of the at least one substance is selected from the group consisting of at least one of an extinction coefficient E and a concentration c of the at least one substance introduced in the volume.

15. The method according to claim 1, wherein the at least one first sensor layer is or comprises at least one semi-transparent sensor layer, wherein the at least one semi-transparent sensor layer is or comprises a structured layer, wherein the structured layer comprises at least one transparent portion and at least one intransparent portion, wherein step c) is performed in a manner that the share of first illumination as guided into the volume only passes the at least one transparent portion of the at least one first optical sensor.
